(19) United States
(12) Patent Application Publication
(10) Pub. No.: US 2022/0185217 A1
(43) Pub. Date: Jun. 16, 2022

(54) VEHICLE CABIN BARRIER SYSTEM

(71) Applicant: Aleksei Chupin, Walnut Creek, CA (US)

(72) Inventor: Aleksei Chupin, Walnut Creek, CA (US)

(21) Appl. No.: 17/120,268

(22) Filed: Dec. 14, 2020

(51) Int. Cl. B60R 21/02

(52) U.S. Cl. CPC B60R 21/026

(57) ABSTRACT

The present invention may provide a barrier system for preventing transmission of disease (i.e., airborne or droplet-based disease) between two occupants of a vehicle, the barrier system comprising a frame adjustable in size and shape to fit the cabin of a plurality of different passenger vehicles, a shield operable to fit over the frame and being impervious to droplets expelled from the nose or mouth of a person, and a securing member operable to hold the barrier system in place.

### FIELD OF THE INVENTION

The present invention relates to barriers for preventing the transmission of diseases. More particularly, embodiments of the present invention pertain to vehicle cabin barriers for blocking air flows and isolating zones between occupants of a vehicle preventing airborne or droplet-based transmission of diseases.

### DISCUSSION OF THE BACKGROUND

Preventing transmission of disease while in a public setting is becoming more and more important to the health of individuals, and since the advent of Covid 19, for the health of the nation in general. One of the primary occasions when people must interact with other members of the public, and wherein disease transmission prevention is vital, is travel. Travel is an essential part of daily life for many people, whether for work, vacation, or simply to get to the grocery store or a restaurant. Most travel involves entering some type of vehicle having an enclosed cabin with less than 6 feet of space between occupants of the vehicle, and thus transmission of Covid 19 and other airborne diseases is a significant concern.

However, often people must share that vehicle cabin with at least one other person who may be a stranger. For instance, many people have grown to depend on ridesharing services such as a taxi, an Uber, a Lyft, a rideshare van, a shuttle and the like. Other people must work as a driver of such vehicles in order to earn a living. Uber, Lyft, taxi, rideshare, and shuttle drivers may end up sharing a cabin with dozens of strangers each day. Despite the prevalence of masks worn for safety, they are not perfect and cannot be counted on to prevent all airborne droplets expelled from a person's nose or mouth. This is especially true when people subconsciously uncover their faces in order to speak, or during or after they cough or sneeze. Thus, what is needed is a more substantial, more permanent barrier (i.e., a driver of a rideshare vehicle and one or more of the many daily passengers of such vehicles) which reduces or eliminates the passage of droplets expelled from a person.

### SUMMARY OF THE INVENTION

The present invention relates to a barrier system which is adaptable to fit into the cabin of virtually any passenger vehicle and substantially reduce the chance of airborne or droplet-based disease transmission between occupants of the vehicle, such as between a driver and a passenger of car qualified for passenger carrying services. Embodiments of the present invention provide a barrier system operable to expand to fit the cross-sectional shape of a cabin of a vehicle. The barrier system may comprise a frame operable to expand in size and a shield operable to fit over the frame, the shield being flexible and substantially impervious to droplets expelled from a person's nose or mouth. The barrier system may therefore be operable to reduce or prevent the spread of diseases such as COVID-19, influenza, the cold virus, tuberculosis, measles, chickenpox, enterovirus, norovirus, and the like between a driver and passenger of a hired car (i.e., a taxi, an Uber, a Lyft, a rideshare, a shuttle, and the like). However, the shield may not be soundproof, and may comprise a substantially transparent section to provide full observation in a rear view mirror and to allow the driver and passenger to hear and see each other, and effectively communicate during the trip.

The barrier may be operable to expand or contract to fit the interior size and shape of multiple different vehicles. In some embodiments, the frame of the barrier may include telescoping lateral support members to increase or decrease the height of the barrier and a telescoping upper horizontal support member to increase or decrease the width of the barrier. Further, the upper corners of the frame may comprise semirigid members operable to flex into the approximate shape of the corners between the roof and side walls of the cabin, and the barrier may include a padded layer which can compress into the exact shape of the interior surface of the cabin. Thus a driver may be able to install the barrier system in a wheel-chair accessible van in the morning to transport regular customers such as the elderly or disabled to and from their scheduled drop-offs, and later in the day easily switch the barrier system into a compact sedan in order to drive for a taxi service, Uber, or Lyft.

The barrier system may further improve the fit between itself and the shape of the cabin by expanding into irregular, recessed shapes in the interior surface of the cabin, such as that caused by a sunroof. In some embodiments, the barrier may include detachable and flexible members (i.e., Velcro®-attached pads) which can be placed on the perimeter of the barrier in a location which aligns with a recessed area of the interior surface of the cabin, effectively expanding the barrier into the recessed area to reduce or eliminate gaps between the barrier and the interior surface.

Additionally, the barrier may be operable to engage with the interior surface of virtually any vehicle, thereby holding the barrier securely in place, in a non-invasive, non-laborious, and esthetically pleasing manner. The barrier system may comprise a securing member on each lateral side, the securing member being operable to engage with the interior surface of the cabin. In some embodiments, the securing member may comprise a rigid extension operable to slide into a seem of the pillar between the front and rear doors of the vehicle, such as sliding behind a rigid cover of the pillar. In other embodiments, the rigid extension may be operable to penetrate the interior surface of the pillar. In yet other embodiments, the securing member may comprise a clamp operable to clamp around the sides of the pillar. The barrier may thus be operable to be quickly secured in place in a vehicle without the use of unsightly adhesives, tape, Velcro patches, or other similar mechanisms attached to the headliner or the material of the lateral posts of the vehicle, which may also cause damage thereto. Such attachment mechanisms are also labor intensive to install, and cannot be transferred from one vehicle to the next in an efficient manner.

The present invention may provide a barrier system for preventing transmission of airborne or droplet-based disease between two occupants of a vehicle, the barrier comprising a frame adjustable in size and shape to fit the cabin of a plurality of different passenger vehicles, and a shield operable to fit over the frame and being impervious to droplets expelled from the nose or mouth of a person.

The frame may comprise any material and any shape operable to support a shield and adjust to have an outer shape complementary to a shape of an interior surface of a cabin of a vehicle. In some embodiments, the frame may comprise at least one of polyvinyl chloride (PVC), high-density polyethylene (HDPE), acrylonitrile butadiene styrene (ABS), polybutylene, polypropylene, polyethylene, polyvinylidene fluoride, and the like. In some embodiments, the frame may comprise at least one of a metal, a metal alloy, carbon fiber, graphene, and the like. In some embodiments, the frame may comprise a plurality of materials. In other embodiments, the frame may comprise a single material. In some embodiments, the frame may comprise a substantially rigid material. In other embodiments, the frame may comprise a semirigid, flexible material.

In some embodiments, the frame may comprise a substantially horizontal member a plurality of lateral members, and at least one securing member. In some embodiments, the horizontal member may be located at an upper perimeter of the frame, adjacent to a ceiling of the cabin of the vehicle (i.e., against the headliner of the vehicle). In other embodiments, the horizontal member may be located at an intermediate height between a floor and a ceiling of the cabin of the vehicle. In yet other embodiments, the horizontal member may be located adjacent to a floor of the cabin of the vehicle. In some embodiments, the frame may comprise a first horizontal member and a second horizontal member. In some embodiments, the first horizontal member may be located adjacent to a ceiling of the vehicle, and the second horizontal member may be located adjacent to a floor of the vehicle. In other embodiments, the first horizontal member bay be located adjacent to the ceiling of the vehicle and the second horizontal member may be located at an intermediate height between the floor and the ceiling of the cabin of the vehicle.

In some embodiments, the plurality of lateral members may be located at a first lateral side of the cabin of the vehicle (i.e., the driver's side) and a second lateral side of the cabin of the vehicle (i.e., the passenger side). In some embodiments, the plurality of lateral members may comprise a first lateral member and a second lateral member, the first lateral member being located adjacent to a first inner surface of the vehicle (i.e., a support post between the driver's door and the rear driver's side door), and the second lateral member being located adjacent to a second inner surface of the vehicle (i.e., a support post between the front passenger side door and the rear passenger side door).

In some embodiments, the horizontal member may have a first end and a second end, the first end being connected to a first lateral member and the second end being connected to a second lateral member. In some embodiments, the first end and the first lateral member may be connected via a first connecting member. The connecting member may comprise a shape complementary to a shape of a first corner of the cabin of the vehicle (i.e., a corner between the ceiling of the cabin and a support post between a front and a rear door of the vehicle). In some embodiments, the second end of the horizontal member and the second lateral member may be connected via a second connecting member. The second connecting member may comprise a shape complementary to a shape of a second corner of the cabin of the vehicle. In some embodiments, the first and second connecting members may comprise a substantially rigid material. In other embodiments, the connecting members may comprise a semi-rigid, flexible material operable to adapt to the shapes of the first corner and second corner of the cabin.

The first connecting member may comprise a first end in communication with the horizontal member and a second end in communication with the first lateral member. In some embodiments, the first end of the first connecting member may be extendably nested within the first end of the horizontal member (i.e., wherein the connecting member may be operable to telescope into and out of the first end of the horizontal member) effectively extending or reducing the overall width of the frame to fit the width of the cabin of the vehicle. In some embodiments, the second end of the connecting member may be extendably nested within an upper end of the first lateral member (i.e., wherein the connecting member may be operable to telescope into and out of the upper end of the first horizontal member) effectively extending or reducing the overall height of the frame to fit the height of the cabin of the vehicle.

In some embodiments, the barrier system may further comprise a lateral extension, the lateral extension extending from a lower end of a lateral member. The lateral extension may comprise a semi-rigid, flexible material, the lateral extension being operable to conform to a shape of lower interior surface of the cabin (i.e., the lower end of the door and the floor pan of the cabin). In some embodiments, the lateral extension may be extendably nested within a lower end of the lateral member, and may thus be operable to extend the length of the lateral member in a telescoping manner. In other embodiments, the lateral extension may be statically attached to a lower end of the lateral member. In some embodiments, the barrier system may comprise a first lower extension extending from a lower end of the first lateral member of the frame, and a second lower extension extending from a lower end of the second lateral member of the frame.

In some embodiments, the plurality of lateral members may comprise a first upper lateral member, a first lower lateral member, a second upper lateral member, and a second lower lateral member. The first upper lateral member and the first lower lateral member may be adjustably connected via a first lateral connector, and the second upper lateral member and second lower lateral member may be adjustably connected via a second lateral connector. The first lateral connecting member may be extendably nested within a lower end of the first upper lateral member and an upper end of the first lower lateral member, the first upper and first lower lateral members being extendable in a telescopic manner from the first lateral connecting member. The second lateral connecting member may be extendably nested within a lower end of the second upper lateral member and an upper end of the second lower lateral member, the second upper and second lower lateral members being extendable in a telescopic manner from the first lateral connecting member.

The first and second lateral connecting members may each comprise a shape complementary to a shape of the lateral posts of the cabin of the vehicle (i.e., a slight inward curving shape around the height of the lower side of the door window). The first and second connecting members may each comprise a semi-rigid, flexible material operable to adapt to the shapes of the lateral posts, or to another shape of the interior surface of the vehicle.

In some embodiments, the horizontal member may comprise a first support member and a second support member, the first support member being extendably nested within the second support member in a telescoping manner. The horizontal member may thus be operable to extend or reduce in length in order to adjust to fit a width of the cabin of the vehicle. In some embodiments, at least one of the plurality of lateral members may comprise a first support member and a second support member, the first support member being extendably nested within the second support member such in a telescoping manner. The at least one of the plurality of lateral members may thus be operable to extend or reduce in length in order to adjust to fit a height of the cabin of the vehicle. In some embodiments, each of the plurality of lateral members may be extendable in a telescoping manner in order to adjust to fit a height of the cabin of the vehicle.

In some embodiments, the frame may comprise at least one locking mechanism for locking a position of a first support member with respect to a second support member, i.e., to prevent telescoping between the first support member and second support member. In some embodiments, the locking mechanism may comprise a twist-tighten mechanism similar to those commonly used for hiking poles. In other embodiments, the locking mechanism may comprise a detent system similar to those commonly used for poles of a shade structure or pool net. In other embodiments, the locking mechanism may be another similar locking system.

In some embodiments, the horizontal member may comprise a locking mechanism operable to lock the first end of the first connecting member in place with respect to the first end of the horizontal member. In some embodiments, the horizontal member may comprise a first support member and a second support member arranged in a telescoping manner, and a locking mechanism operable to lock the first support member in place with respect to the second support member. In some embodiments, the plurality of lateral members may each comprise a locking mechanism operable to lock the second ends of a connecting members in place with respect to the upper ends of the plurality of lateral members. In some embodiments, the plurality of lateral members may each comprise a first support member and a second support member arranged in a telescoping manner, and a locking mechanism operable to lock the first support member in place with respect to the second support member.

The frame may comprise at least one securing member for securing the frame in position in the cabin of the vehicle. The securing member may comprise any mechanism operable to engage with a surface of the cabin of the vehicle to hold the frame in place. The securing member may comprise any material of sufficient strength to hold the barrier in place in the cabin of the vehicle. In some embodiments, the securing member may comprise a rigid material. In other embodiments, the securing member may comprise a semi-rigid, flexible material. In some embodiments, the securing member may comprise at least one of a metal, a metal alloy, graphene, carbon fiber, a plastic, a wood, and the like.

In some embodiments, the securing member may comprise rigid extension having a tapering distal end operable to intercalate a seem of an interior surface of the cabin of the vehicle. In some embodiments, the seem may comprise an edge of a rigid cover of a support post of the vehicle (i.e., a post between the front door and rear door of the vehicle. In other embodiments, the seem may comprise the interface between two sections of the material covering the interior surface of the cabin.

In some embodiments, the securing member may comprise a substantially flat extension (i.e., a tab) operable to slide behind a cover of the support post or into a seem between sections of material of the interior surface of the cabin. In some embodiments, the securing mechanism may comprise a clamp or clip operable to fit around and engage (i.e., squeeze) the sides of a support post of the vehicle. In some embodiments, the securing member may comprise a shape approximating the shape of a pin operable to pierce the material covering the interior surface of the cabin of the vehicle.

In other embodiments, the securing member may comprise a hook shape. In some embodiments, the hook shape may be operable to engage with a support structure of the cabin of the vehicle (i.e., a clothes hanger support, a spring-loaded handle above the door, a seatbelt securing structure, and the like).

In some embodiments, the securing member may comprise a plurality of securing members operable to engage with a plurality of locations of the interior surface of the cabin of the vehicle. In some embodiments, the plurality of securing members may comprise a first securing member located at a first end of the horizontal member, and a second securing member located at a second end of the horizontal member. In some embodiments, the plurality of securing members may comprise four or more securing members arranged at the first and second ends of the horizontal member and at the lower ends of the lateral members.

The shield may comprise any mechanism operable to provide engage with the frame and provide a barrier against the passage of a communicable disease from a first area of a vehicle (i.e., a back seat area) to a second area of a vehicle (i.e., a the area around the driver's seat of the vehicle). The shield may comprise any material operable to prevent the passage of droplets of a bodily fluid expelled from a person (i.e., droplets of saliva, mucous, and the like, expelled via breathing, coughing, sneezing, speaking, and the like) from passing through the shield. In some embodiments, the shield may comprise a substantially supple material operable to fold up or stretch out as the size or shape of the frame is adjusted to fit the size or shape of the cabin of the vehicle.

In some embodiments, the shield may comprise a material having antimicrobial properties, i.e., having a non-porous surface, comprising an antimicrobial agent surface treatment, comprising an antimicrobial element such as copper or silver threads. In some embodiments, the shield may comprise an antimicrobial fabric operable to prevent bacteria and other microorganisms from attaching to the fabric surface. In some embodiments, the shield may comprise at least one of a polyester, a polyester-vinyl composite, vinyl, acrylic, another plastic or rubber material, a woven material, cloth, leather, and the like. In some embodiments, the shield may be substantially impervious to droplets expelled from a person.

The shield may engage with the frame in a manner which substantially prevents any open gaps between the shield and the frame, and between the shield and the interior surface of the cabin of the vehicle. In some embodiments, the shield may wrap around the members of the frame. In some embodiments, the shield may wrap around the horizontal member, each of the plurality of lateral members, and each of the connecting members of the frame, and securely engage with itself after wrapping around frame, i.e., via at least one of a sewing, an adhesive, a hook and loop mechanism such as Velcro®, a zipper, a snap, a button, a hooks, a rings, and the like. The shield may thereby substantially cover at least a portion of the outer perimeter of the frame (i.e., the top and two lateral sides of the frame) and thereby be positioned to come in contact with the interior surfaces of the ceiling and two lateral sides of the cabin of the vehicle. In some embodiments, the shield may wrap around all support members of the frame, thus covering the entire outer perimeter of the frame. In other embodiments, the shield may not wrap around all areas of the frame.

In some embodiments, the shield may comprise a securing passage adjacent to a support member of the frame to allow for one or more securing members of the frame to pass through the shield and engage with the interior surface of the cabin of the vehicle. In some embodiments, the one or more passages may comprise a grommet. In other embodiments, the one or more passages may comprise a slit operable to minimize any open area between the interior of the passage and the securing member. In some embodiments, the securing passage may comprise a plurality of securing passages arranged to allow the passage of a plurality of securing members through the shield.

The shield may comprise a window operable to allow the occupants of the vehicle on each side of the barrier system to view each other. The window may comprise any material which is substantially transparent (i.e., operable to allow a person to see through it) and operable to prevent the passage of droplets expelled from a person. In some embodiments, the window may comprise a semi-rigid and flexible material. In other embodiments, the window may comprise a supple material. In yet other embodiments, the window may comprise a substantially rigid material. In some embodiments, the window may comprise at least one of a polyester, a polyester-vinyl composite, vinyl, acrylic, another plastic, a glass, plexiglass, fiberglass, and another similar transparent material operable to prevent the passage of droplets expelled from a person. In some embodiments, the window may comprise a first material, and the remaining portion of the shield may comprise a second material, the first material being substantially transparent. In other embodiments, substantially all of the shield may comprise a transparent material. In some embodiments, the window may be located at face height while a person is sitting in the vehicle, and the window may be located substantially centrally between two occupants of the vehicle.

The barrier system may further comprise a shaping member operable to supplement the shape of the frame to fill in an area where the interior surface of the cabin comprises an irregular shape (i.e., at a sunroof, a door window or door console, or other depression or protrusion in the interior surface), thus providing substantially unbroken contact between the barrier and the interior surface. The shaping member may be operable to adopt a shape of the interior surface of the cabin when under pressure against the interior surface, pushing the edge of the shield or a protective cover of the shaping member against the interior surface of the cabin to reduce or eliminate gaps between the barrier or protective cover and the interior surface. The shaping member may comprise any material and shape operable to adjust to an irregular (i.e., non-flat) shape of the interior surface of the cabin, thus substantially preventing or filling in a gap between the outer perimeter of the frame and the interior surface of the cabin. In some embodiments, the shaping member may be removably attachable to the frame (i.e., operable to securely wrap around a portion of the frame) and operable to securely attach to any portion of the frame in order to supplement the shape of such portion of the frame. In other embodiments, the shaping member may cover the entire outer perimeter of the frame and be permanently attached to the frame.

In some embodiments, the shaping member may be located substantially centrally on the horizontal member of the frame in order to prevent a gap between the frame and the sunroof of the vehicle. In some embodiments, the shaping member may comprise a plurality of shaping members. In some embodiments, the plurality of shaping members may comprise first and second shaping members positioned at the upper corners of the frame (i.e., wrapped around the first and second connecting members) in order to prevent gaps at the corners between the walls and ceiling of the cabin of the vehicle. In yet other embodiments, the shaping member may be located on a lateral member of the frame in order to prevent a gap between the frame and a window of a door of the vehicle.

In some embodiments, the shaping member may comprise a substantially cylindrical shape having a longitudinal slit, and thus be operable to installed on and wrap around a support member of the frame. In such embodiments, the shaping member may function similarly to a cylindrical pad for a weight-lifting bar. In some embodiments, the shaping member may comprise a substantially pliable material operable to compress in areas under pressure from contact with the interior surface of the cabin. In some embodiments, the shaping member may comprise at least one of a foam material, a fibrous web material, an encased gel, low density polyethylene, and the like. In some embodiments, the shaping member may be located between the frame and the shield (i.e., inside the portion of the shield which wraps around the frame). In other embodiments, the shaping member may be located between the shield and the interior surface of the cabin (i.e., outside the portion of the shield which wraps around the frame.

In some embodiments, the shaping member may comprise an inner, compressible material and an outer, protective cover, the protective cover being substantially impervious to droplets expelled from a person. In some embodiments, the protective cover may comprise the same material as the shield. In other embodiments, the portion of the shield wrapping around the shaping member may be operable to act as a protective cover. In some embodiments, the protective cover may removably attach to at least one of the shield and the frame. In some embodiments, the protective cover may attach to the shield or frame via at least one of a sewing, an adhesive, a hook and loop mechanism such as Velcro®, a zipper, a snap, a button, friction caused by the shape of a cylindrical shaping member wrapped around the shield or frame, compression between the shield or frame and the interior surface of the cabin, and the like.

The barrier system may comprise a supplemental securing member, the supplemental securing member comprising any mechanism operable to secure the shield to a support structure of the vehicle (i.e., a driver's seat or front passenger seat). In some embodiments, the supplemental securing member may comprise a strap operable to wrap around a headrest of a seat of the vehicle. In some embodiments, the strap may be secured around the seat of the vehicle via at least one of tying two ends of the strap together, a sewing, an adhesive, a hook and loop mechanism such as Velcro®, a zipper, a snap, a button, and the like. In some embodiments, the supplemental securing member may comprise an elastic material operable to stretch out around a wide portion of the headrest (i.e., the cushion of the headrest) and contract to secure around a narrow portion of the headrest (i.e., the lower support posts of the headrest). In some embodiments, the supplemental securing member may comprise a hook operable to secure to a support post of the seat headrest. In some embodiments, the supplemental securing member may comprise a plurality of supplemental securing members operable to secure the shield to a plurality of support structures of the vehicle (i.e., two straps positioned to secure around the support posts of the driver's headrest and the front passenger headrest).

The barrier system may comprise an extension member operable to extend the shield in a vehicle having an unusually wide or unusually tall cabin. The extension member may comprise the same material as the shield and may removably attach to the shield via at least one of an adhesive, a hook and loop mechanism such as Velcro®, a zipper, a snap, a button, and the like. In some embodiments, the extension member may removably attach to the shield at a location adjacent to the bottom of the shield (i.e., near the lower edge of the shield) and may be operable to effectively extend the height of the shield. In other embodiments, the extension member may removably attach to the shield at a location adjacent to a lateral side of the shield (i.e., near the left or right edge of the shield) and may be operable to extend the width of the shield. In some embodiments, the extension member may comprise a rigid or semi-rigid extension support member, so as to ensure that the extension member is fully extended vertically or horizontally.

The barrier system may comprise a console passage, console passage comprising an opening in the shield positioned to allow a console of the vehicle (i.e., the center console between the driver and front passenger seat) to pass through the shield. The rear side of the console may therefore protrude into the passenger side of the barrier system, allowing access to the console by a passenger of the vehicle. The barrier system may thereby allow services provided at the rear side of the console (i.e., climate control vents, power outlets, cup holders, and the like) to be accessible by the passenger. The console passage may comprise a shape complementary to an outer shape of the console, reducing or eliminating any openings between the console and the console passage.

### BRIEF DESCRIPTION OF THE DRAWINGS

FIGS. 1A and 1B show perspective views of a frame of a barrier system for preventing transmission of disease in a vehicle, according to an embodiment of the present invention.

FIGS. 2A and 2B show perspective views of a frame of a barrier system for preventing transmission of disease in a vehicle, according to an embodiment of the present invention.

FIGS. 3A and 3B show perspective views of a frame of a barrier system for preventing transmission of disease in a vehicle, according to an embodiment of the present invention.

FIGS. 4A and 4B show perspective views of a frame of a barrier system for preventing transmission of disease in a vehicle, according to an embodiment of the present invention.

FIGS. 5A and 5B show perspective views of a barrier system for preventing transmission of disease in a vehicle, according to an embodiment of the present invention.

FIGS. 6A and 6B show perspective views of a barrier system for preventing transmission of disease in a vehicle, according to an embodiment of the present invention.

FIGS. 7A and 7B show perspective views of a barrier system for preventing transmission of disease in a vehicle, according to an embodiment of the present invention.

FIGS. 8A-8C each show a side, cross-section view of elements of a barrier system for preventing transmission of disease in a vehicle, according to an embodiment of the present invention.

FIGS. 9A and 9B show perspective views of elements of a barrier system for preventing transmission of disease in a vehicle being installed in a cabin of a vehicle, according to an embodiment of the present invention.

FIG. 9C shows a perspective view of a elements of a barrier system for preventing transmission of disease in a vehicle installed in a cabin of a vehicle, according to an embodiment of the present invention.

FIG. 9D shows a perspective view of a barrier system for preventing transmission of disease in a vehicle installed in a cabin of a vehicle, according to an embodiment of the present invention.

FIGS. 10A and 10B show perspective views of elements of a barrier system for preventing transmission of disease in a vehicle being installed in a cabin of a vehicle, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided

The present invention may provide a barrier system 100 for preventing transmission of disease (i.e., airborne or droplet-based disease) between two occupants of a vehicle, the barrier system comprising a frame 110 adjustable in size and shape to fit the cabin 199 of a plurality of different passenger vehicles, and a shield 150 operable to fit over the frame and being impervious to droplets expelled from the nose or mouth of a person.

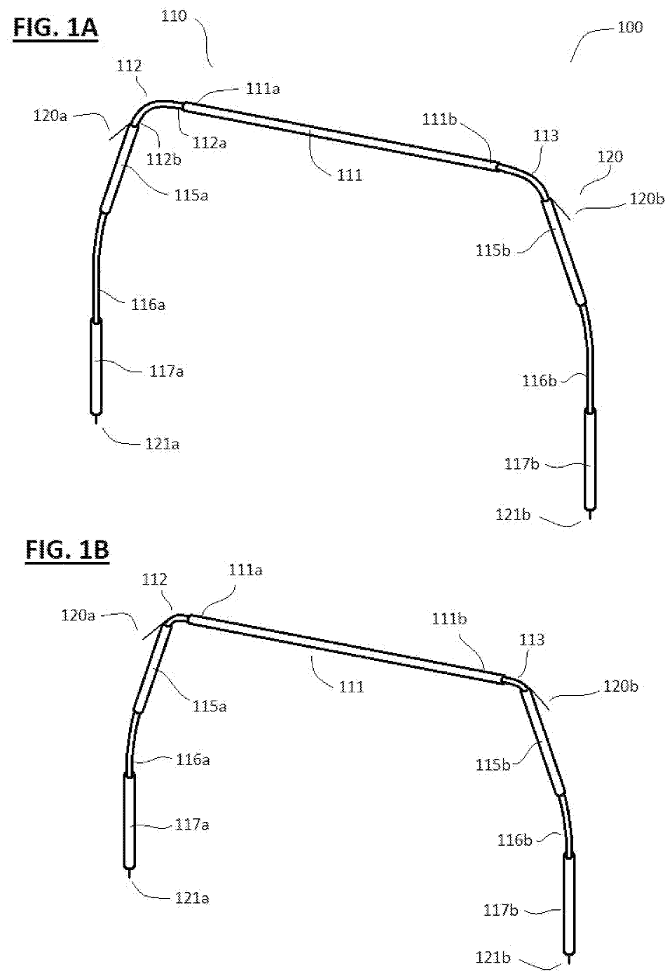

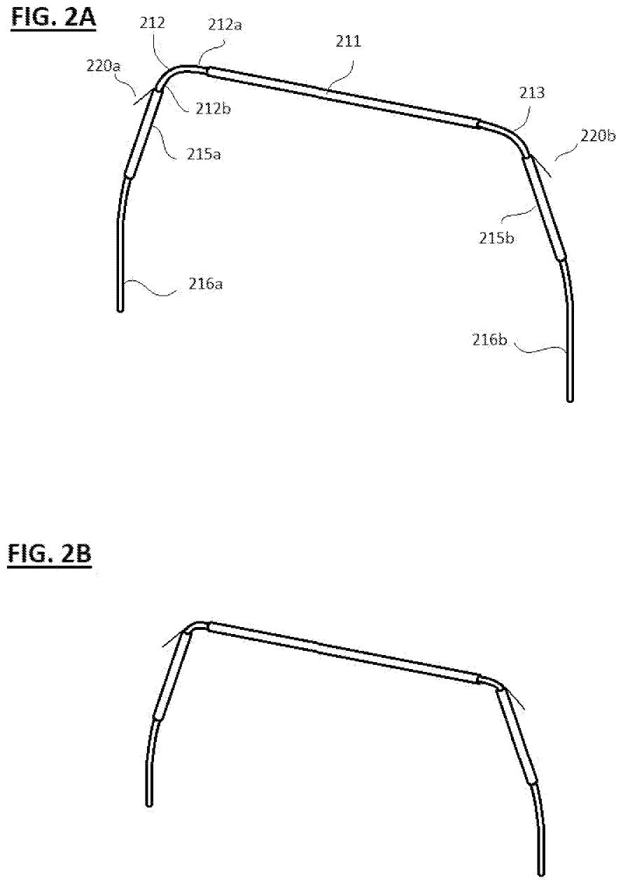

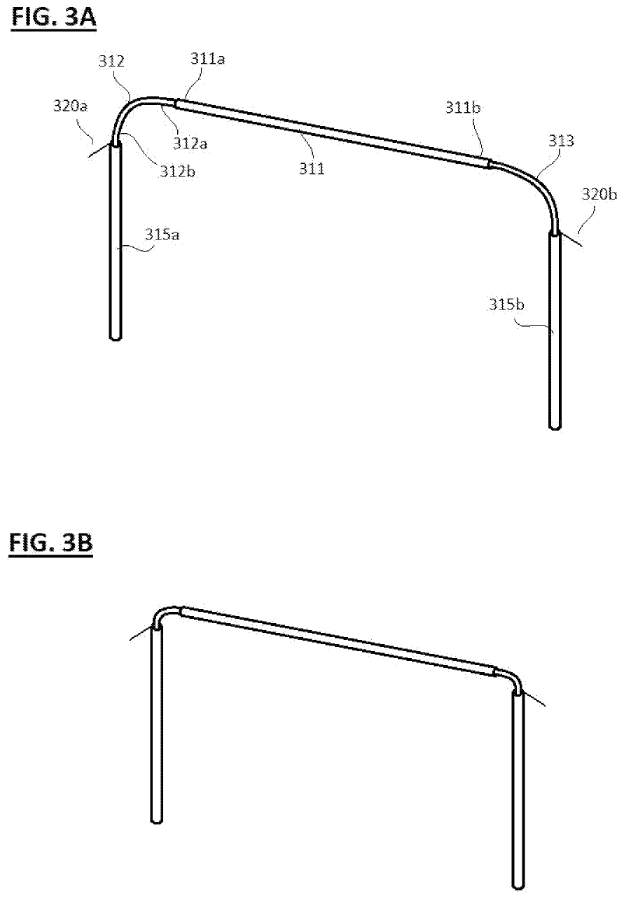

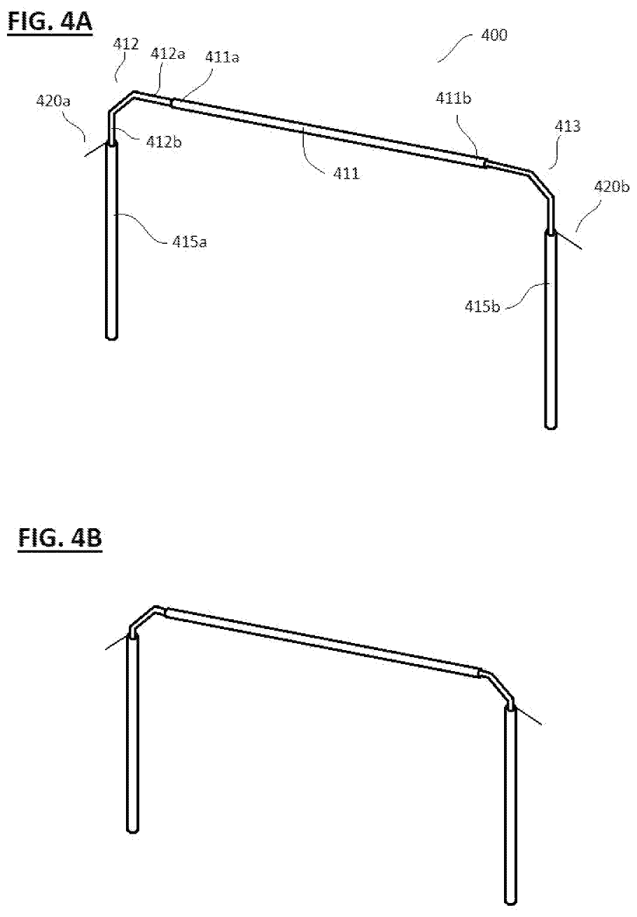

Embodiments of the present invention shown in FIGS. 1A-1B, 2A-2B, 3A-3B, 4A-4B, 9A-9C, and 10A-10B are depicted without the shield 150. This is done for clarity, so as to see the details of the frame 110, while in practice the shield 150 would be present.

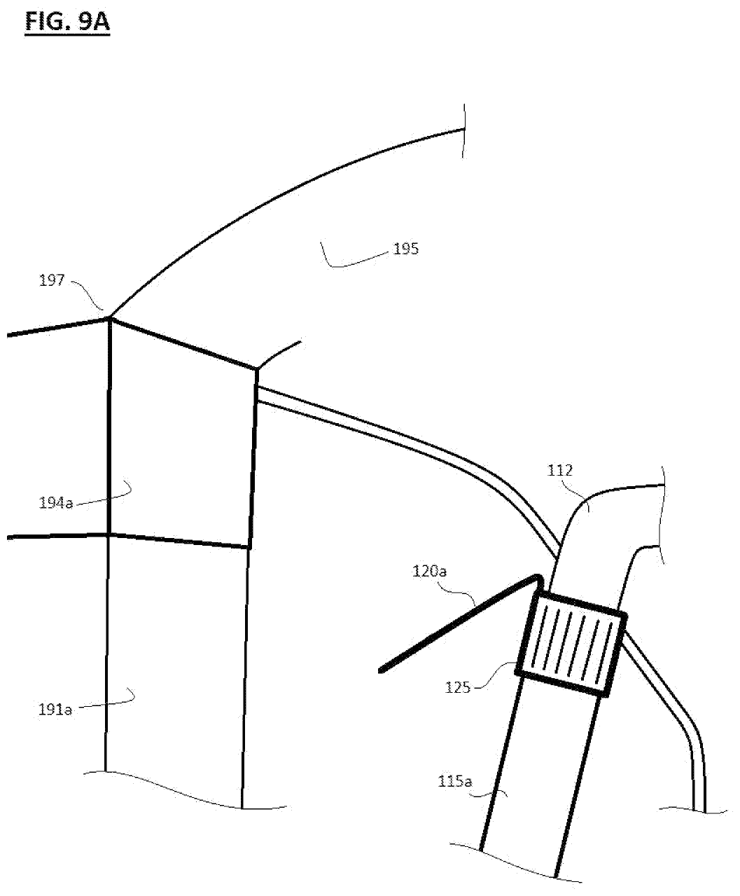

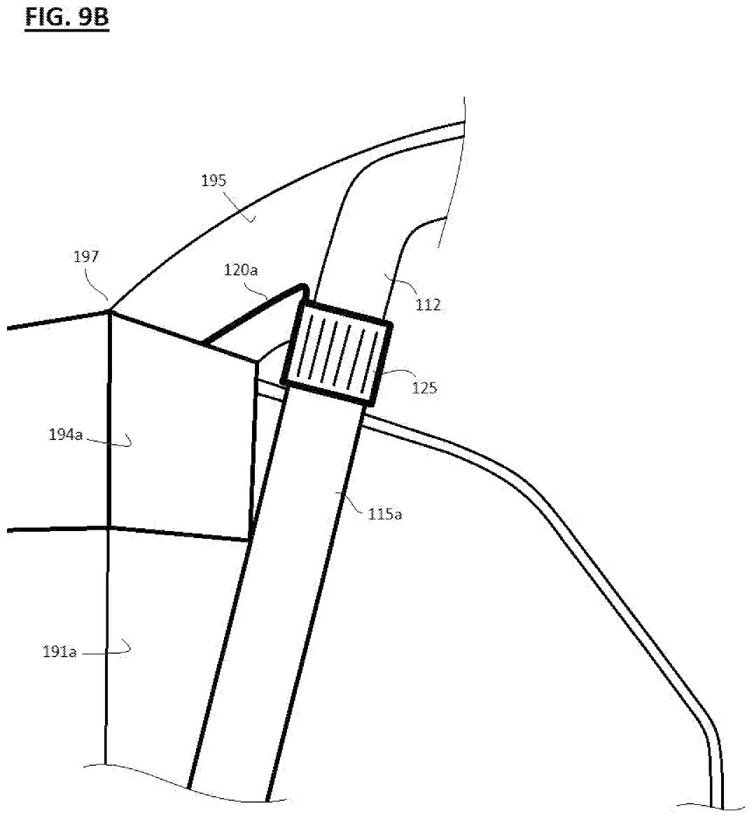

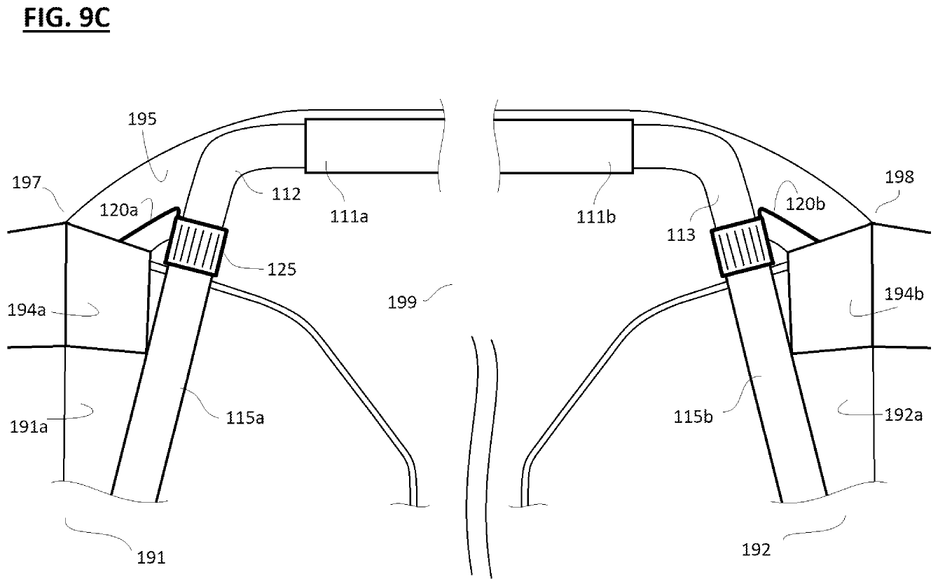

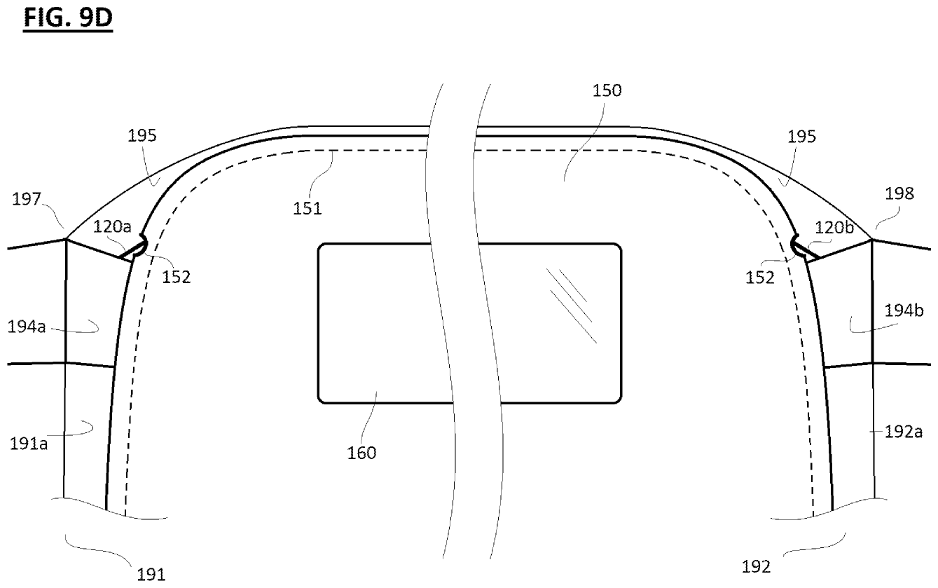

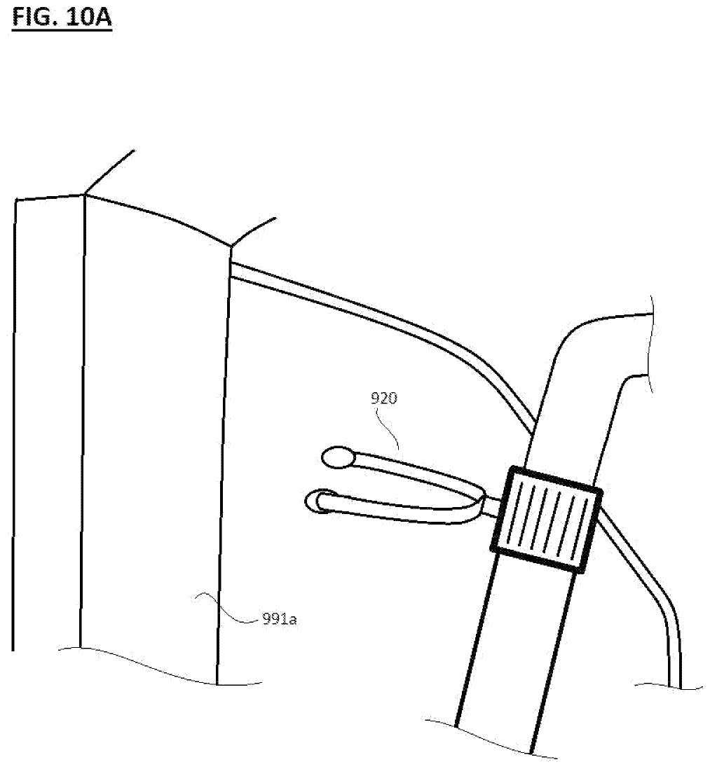

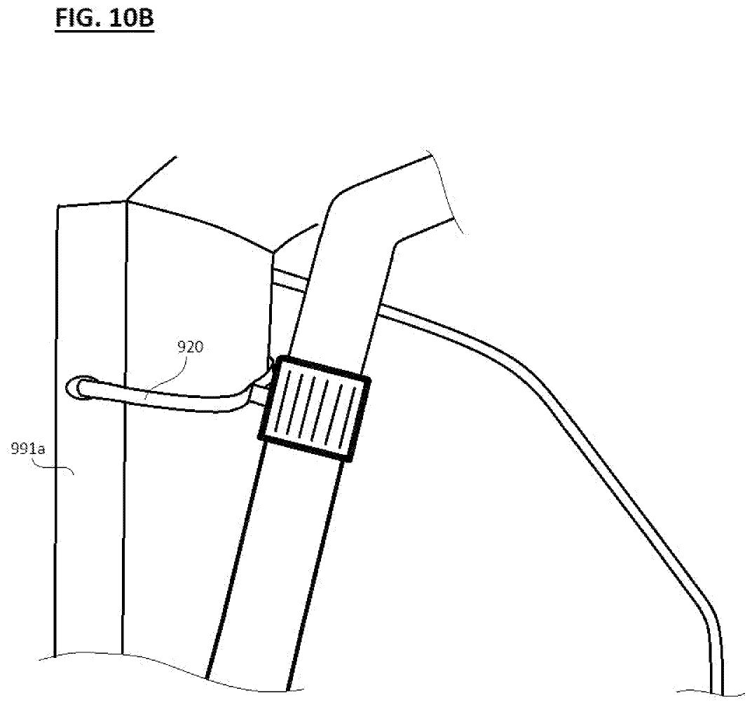

As seen in FIG. 1, the frame 110 may comprise a substantially horizontal member 111, a plurality of lateral members 115, and at least one securing member 120. The horizontal member 111 may be located at an upper perimeter of the frame 110, adjacent to a ceiling 195 of the cabin 199 of the vehicle (see FIGS. 9B and 10B). The plurality of lateral members 115 may be located at a first lateral side 191 of the cabin 199 (i.e., the driver's side) and a second lateral side 192 of the cabin 199 (i.e., the passenger side, see FIG. 9C). The plurality of lateral members 115 may comprise a first lateral member 115a and a second lateral member 115b, the first lateral member 115a being located adjacent to a first inner surface 191a of the vehicle 199 (i.e., a support post between the driver's door and the rear driver's side door), and the second lateral member 115b being located adjacent to a second inner surface 192a of the vehicle 199 (i.e., a support post between the front passenger side door and the rear passenger side door).

The horizontal member 111 may have a first end 111a and a second end 111b, the first end 111a being connected to the first lateral member 115a and the second end 111b being connected to the second lateral member 115b. The first end 111a and the first lateral member 115a may be connected via a first connecting member 112, the first connecting member 112 comprising a shape complementary to a shape of a first corner 197 (see FIG. 9C) of the cabin 199 (i.e., a corner between the ceiling of the cabin and a support post between a front and a rear door of the vehicle). The second end 111b the second lateral member 115b may be connected via a second connecting member 113. The second connecting member 113 may comprise a shape complementary to a shape of a second corner 198 of the cabin 199. The first and second connecting members 112, 113 may each comprise a semi-rigid, flexible material operable to adapt to the shapes of the first corner 197 and second corner 198 of the cabin 199.

The first connecting member 112 may comprise a first end 112a and a second end 112b. The first end 112a may be extendably nested within the first end 111a of the horizontal member 111 (i.e., wherein the connecting member 112 may be operable to telescope into and out of the first end 111a of the horizontal member 111) effectively extending (see FIG. 1A) or reducing (see FIG. 1B) the overall width of the frame 110 to fit the width of the cabin 199. The second end 112b of the connecting member 112 may be extendably nested within an upper end of the first lateral member 115a (i.e., wherein the connecting member 112 may be operable to telescope into and out of the upper end of the first horizontal member 115a) effectively extending (see FIG. 1A) or reducing (see FIG. 1B) the overall height of the frame 110 to fit the height of the cabin 199.

The barrier system 100 may further comprise a first lateral extension 116a and a second lateral extension 116b, the first and second lateral extensions 116a, 116b extending from lower ends of the first and second lateral members 115a, 115b, respectively. The first and second lateral extensions 116a, 116b may each comprise a semi-rigid, flexible material, and be operable to conform to a shape of lower interior surface of the cabin 199 (i.e., the lower end of the door and the floor pan of the cabin). The first and second lateral extensions 116a, 116b may be extendably nested within the lower ends of the first and second lateral members 115a, 115b, respectively, and may thus be operable to extend from the first and second lateral members 115a, 115b in a telescoping manner.

The frame 110 may further comprise a first lower lateral member 117a and a second lower lateral member 117b. The first lateral member 115a and the first lower lateral member 117a may be adjustably connected via the a first lateral extension 116a, and the second lateral member 115b and second lower lateral member 117b may be adjustably connected via the second lateral extension 116b. The first lateral extension 116a may be extendably nested within an upper end of the first lower lateral member 117a in a telescopic manner and the second lateral extension 116b may be extendably nested within an upper end of the second lower lateral member 117b in a telescopic manner.

The frame may comprise at least one locking mechanism 125 for locking a position of a first support member (i.e., the first lateral member 115a) with respect to a second support member (i.e., the first connecting member 112) to prevent telescoping movement between them. The locking mechanism 125 may comprise a twist-tighten mechanism similar to those commonly used for hiking poles.

The frame 110 may comprise at least one securing member 120 for securing the frame 110 in position in the cabin 199 of the vehicle. The securing member 120 may comprise a rigid extension operable to engage with a surface of the cabin 199 to hold the frame 110 in place. The rigid extension 120 may have a tapering distal end operable to insert behind an edge of a rigid cover 194 of a support post of the vehicle. The at least one securing member 120 may comprise a first securing member 120a operable to engage with a first rigid cover 194a of the cabin 199, a second securing member operable to engage with a second rigid cover 194b of the cabin 199, a first lower securing member 121a operable to engage with the floor (i.e., carpet) on the first side 191 of the cabin and a second lower securing member 121b operable to engage with the floor on the second side 192 of the cabin.

In another embodiment of the present invention, the securing member 920 may comprise a clamp operable to fit around and engage (i.e., squeeze) the sides of the support post 991a of the vehicle (see FIGS. 10A and 10B).

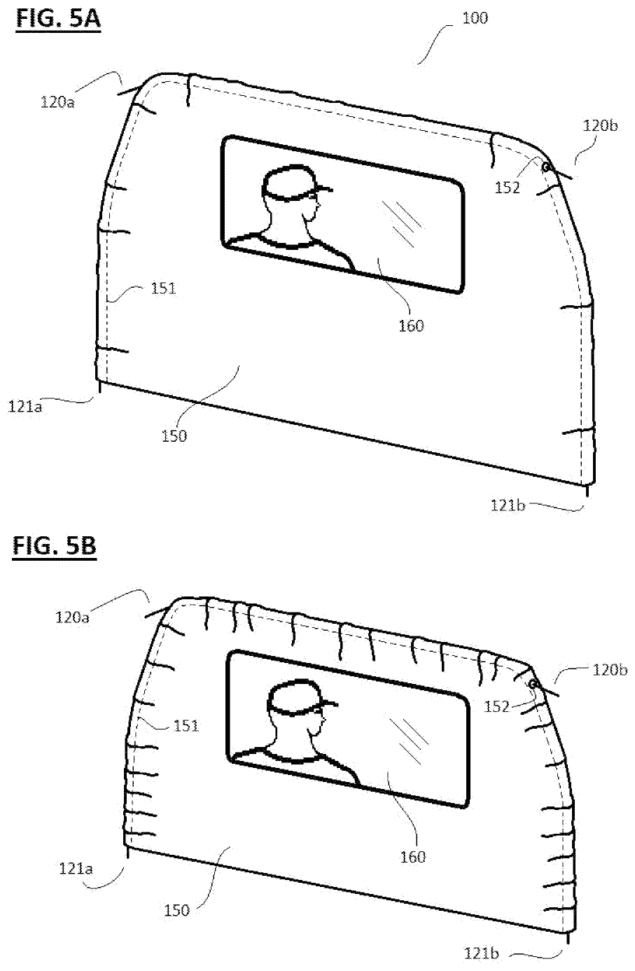

As seen in FIGS. 5A and 5B, the shield 150 may comprise a substantially supple material operable to fold up (see FIG. 5B) or stretch out (see FIG. 5A) as the size or shape of the frame 110 is adjusted to fit the size or shape of the cabin 199 of the vehicle. The shield 150 may engage with the frame 110 in a manner which substantially prevents any open gaps between the shield 150 and the frame 110, and between the shield 150 and an interior surface (i.e., the ceiling 195) of the cabin 199 of the vehicle.

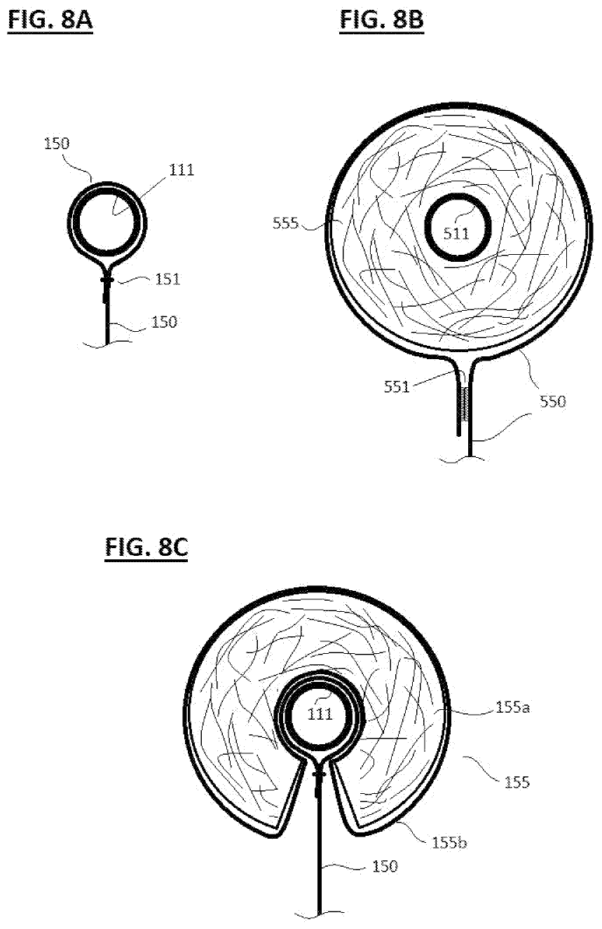

As seen in FIG. The shield 150 may wrap around the members (i.e., the horizontal member 111) of the frame 110. The shield 150 may wrap around the horizontal member 111, each of the plurality of lateral members 115, and each of the connecting members 112, 113 of the frame 110, the shield 150 securely engaging with itself after wrapping around frame 150. The shield 150 may securely engage with itself via an attachment mechanism 151. The attachment mechanism may comprise at least one of a sewing (see FIG. 8A), a hook and loop mechanism such as Velcro® (see FIG. 8B), and an adhesive (see FIG. 8C). The shield 150 may thereby substantially cover at least a portion of frame 110 and thereby be positioned to come in contact with the interior surfaces of the ceiling 195 and two lateral sides 191a, 192a of the cabin 199 of the vehicle (see FIG. 9D).

The shield 150 may comprise a window 160 operable to allow the occupants of the vehicle on each side of the barrier system 100 to view each other. The window 160 may be located at face height while a person is sitting in the vehicle (see, i.e., FIG. 5A). The shield may comprise a plurality of securing passages 152 adjacent to a support member (i.e., a lateral member 115) of the frame 110 to allow for the securing members 120a, 120b to pass through the shield 150 and engage with the interior surface 194a of the cabin 199. The securing passages 152 may each comprise a grommet.

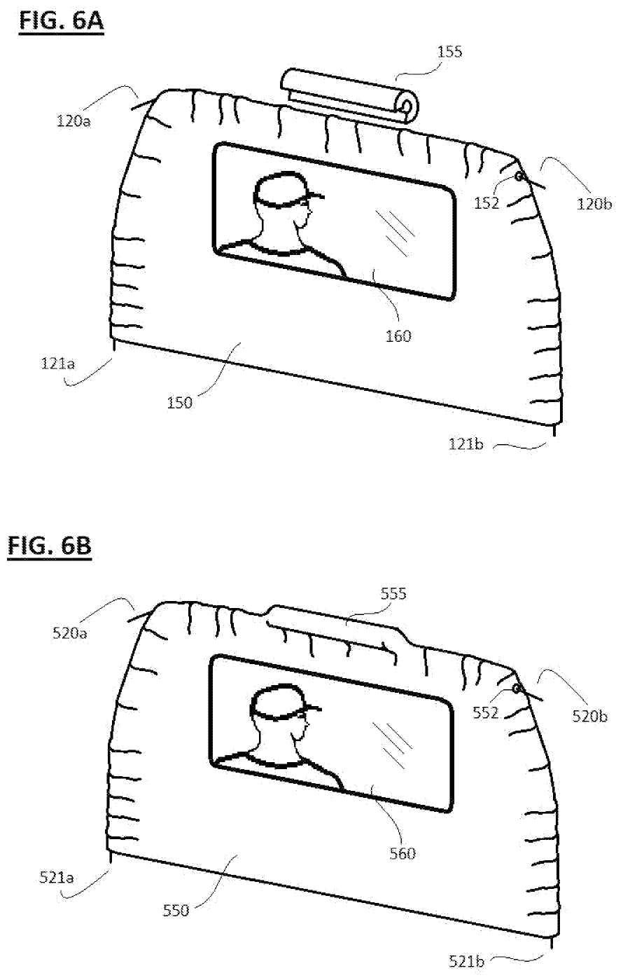

As seen in FIGS. 6A, 6B, 8B, and 8C, the barrier system 100 may further comprise a shaping member 155 operable to supplement the shape of the frame 110 to fill in an area where the interior surface of the cabin 199 comprises an irregular shape (i.e., at a sunroof), thus providing substantially unbroken contact between the barrier 100 and the interior surface. The shaping member 155 may be removably attachable to the frame 110 (see FIGS. 6A and 8C) operable to securely wrap around a portion (i.e., the horizontal member 111) of the frame 110. In another embodiment, the shaping member 555 may be permanently attached to the frame (see FIGS. 6B and 8B). The shaping member 155/555 may comprise a fibrous web material.

In one embodiment, the shaping member may comprise an inner, compressible material 155a and an outer, protective cover 155b, the protective cover 155b being substantially impervious to droplets expelled from a person (see FIG. 8C). The protective cover 155b may comprise the same material as the shield 150. In another embodiment, the portion of the shield 550 wrapping around the shaping member 555 may be operable to act as a protective cover (see FIG. 8B).

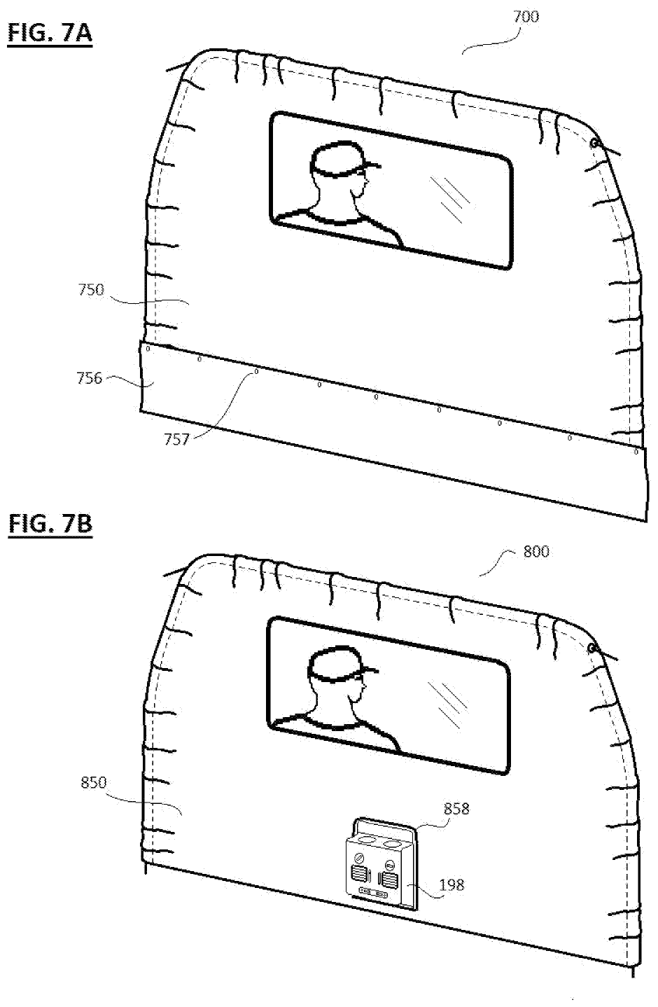

In one embodiment, the barrier system 700 may comprise an extension member 756 operable to extend the shield 750 in a vehicle having an unusually tall cabin. The extension member 756 may comprise the same material as the shield 750 and may removably attach to the shield 750 via an extension attachment mechanism 757 (i.e., a plurality of snaps). The extension member 756 may removably attach to the shield 750 at the lower edge thereof and may be operable to effectively extend the height of the shield 750 (see FIG. 7A).

In one embodiment, the barrier system 800 may comprise a console passage 858 comprising an opening in the shield 850 positioned to allow a console 198 of the vehicle (i.e., the center console between the driver and front passenger seat) to pass through the shield 850. The rear side of the console 198 may therefore protrude into the passenger side of the barrier system 800, allowing access to the console 198 by a passenger of the vehicle. The barrier system 800 may thereby allow services provided at the rear side of the console 198 (i.e., climate control vents, power outlets, cup holders, and the like) to be accessible by the passenger. The console passage 858 may comprise a shape complementary to an outer shape of the console 198, reducing or eliminating any openings between the console 198 and the console passage 858.

What is claimed:

1. A barrier system for preventing transmission of a disease between two occupants in a cabin of a vehicle, the system comprising:
a. a frame; and
b. a shield supported by said frame.

2. The system of claim 1, wherein said frame comprises a securing member for securing said frame to an interior surface of said cabin.

3. The system of claim 2, wherein said securing member comprises a rigid extension operable to engage with a seem of said interior surface.

4. The system of claim 3, wherein said interior surface comprises a pillar between a front door and a rear door of said cabin and said seem comprises an edge of a cover for said pillar.

5. The system of claim 2, wherein said securing member comprises a plurality of securing members arranged at different positions along a perimeter of said frame, wherein said plurality of securing members comprises a first rigid extension operable to engage with a first seem of said interior surface and a second rigid extension operable to engage with a second seem of said interior surface.

6. The system of claim 1, wherein said shield comprises a flexible material substantially impervious to droplets expelled from a person's nose or mouth.

7. The system of claim 1, further comprising a shaping member operable to conform to a shape of said cabin, said shaping member being operable to substantially reduce any gaps between said barrier system and an interior surface of said cabin.

8. The system of claim 7, wherein the shaping member is arranged at a perimeter of said shield.

9. The system of claim 8, wherein said shaping member comprises a pliable material wrapped around a support member of said frame, said pliable material being operable to conform to a shape of said interior surface of said cabin when said shaping member is pressed against said interior surface.

10. The system of claim 9, wherein said shaping member and said shield each comprise a passage for allowing a securing member of said frame to pass therethrough and secure said frame to said interior surface.

11. The system of claim 1, further comprising at least one supplemental securing member for securing said shield to a support structure of said vehicle.

12. The system of claim 11, wherein said supplemental securing member comprises a plurality of adjustable straps extending from said shield and said support structure comprises at least one seat of said vehicle.

13. The system of claim 1, wherein said shield comprises a console passage, said console passage comprising a shape complementary to an outer shape of a center console of said vehicle and allowing access by said passenger to a rear surface of said center console.

14. The system of claim 1, further comprising an extending member, said extending member being removably attachable at a perimeter of said shield and operable to fill a gap between said shield and a surface of said cabin.

15. The system of claim 1, wherein said frame comprises a plurality of interlocking rigid or semirigid support members.

16. The system of claim 15, wherein said frame is operable to conform to a shape complementary to an interior cross-sectional shape of said cabin.

17. The system of claim 16, wherein said frame comprises at least one telescoping member, said telescoping member comprising a first member extendably nested inside a second member.

18. The system of claim 17, wherein said frame comprises a rigid horizontal member, a rigid first lateral member, a rigid second lateral member, a semi-rigid first connecting member extendably nested within a first end of said horizontal member and within an upper end of said first lateral member, and a semi-rigid second connecting member extendably nested within a second end of said horizontal member and within an upper end of said second lateral member.

19. A barrier system for preventing transmission of a disease between two occupants in a cabin of a vehicle, the system comprising an adjustable frame, an expandable shield supported by said frame, and a securing member for securing said frame to a support structure of said vehicle.

20. A method of using a barrier system for preventing transmission of a disease between two occupants in a cabin of a vehicle, the method comprising the steps of:
a. providing said barrier system comprising an adjustable frame, an expandable shield supported by said frame, and a securing member for securing said frame to a support structure of said vehicle;
b. adjusting a shape of said frame; and
c. engaging said securing member with said support structure of said vehicle.
